(19) United States
(12) Patent Application Publication
(10) Pub. No.: US 2010/0293508 A1
(43) Pub. Date: Nov. 18, 2010

(54) METHOD FOR CONTROLLING ICON POSITION AND PORTABLE TERMINAL ADAPTED THERETO

(75) Inventors: Soon Shik HWANG, Gyeongsangbuk-do (KR); Moon Heui LEE, Gyeongsangbuk-do (KR)

Correspondence Address: CHA & REITER, LLC, 210 ROUTE 4 EAST STE 103, PARAMUS, NJ, 07652, US

(73) Assignee: SAMSUNG ELECTRONICS CO., LTD., Gyeonggi-Do (KR)

(21) Appl. No.: 12/777,818

(22) Filed: May 11, 2010

(30) Foreign Application Priority Data
May 14, 2009 (KR) 10-2009-0042144

(51) Int. Cl. G06F 3/048

(52) U.S. Cl. 715/846

(57) ABSTRACT

An icon position movement controlling method and a portable terminal adapted to the method are disclosed. When icons are displayed on the display unit of the portable terminal, if a position movement locking function is set, the position of the icon can be locked so that they are not moved by a touch event that has occurred on the display unit or a screen of the display unit. A position movement releasing function can release the locked icons. Therefore, the icons can be prevented from moving due to unintentional touch events.

### CLAIM OF PRIORITY

This application claims, pursuant to 35 USC 119(a), priority to, and benefit of, the earlier filing date to that patent application entitled “Method for Controlling Icon Position and Portable Terminal Adapted Thereto,” filed in the Korean Patent Office on May 14, 2009 and afforded serial number 10-2009-0042144, the contents of which are incorporated by reference, herein.

### BACKGROUND OF THE INVENTION

1. Field of the Invention

The present invention relates to portable terminals, and more particularly, to a method that can selectively prohibit changes in the position of icons displayed on a touch screen.

2. Description of the Related Art

In recent years, portable terminals have been widely used because they can be easily carried. These conventional portable terminals provide a variety of functions, such as a file playback function, an MP3 player, and an image collecting function, such as a digital camera. The conventional portable terminals can also support functions for playing mobile games or arcade games, etc. As the number of functions capable of being provided by the portable terminal, increases, the size of the display unit of the portable terminal is also becoming larger. Some of the conventional portable terminals have recently been configured in such a way that one side employs a touch screen with a full display panel.

When the conventional portable terminals with a touch screen are manufactured as a slide type, they are disadvantages in that touch events on their touch screen may easily occur while being opened. In that case, unintended operations are performed.

### SUMMARY OF THE INVENTION

The present invention provides a method that can move or fix various menus and icons on a touch screen of a portable terminal according to a user's request.

The present invention further provides a portable terminal adapted to the method for controlling the position of various menus and icons on a touch screen of the portable terminal.

In accordance with an exemplary embodiment of the present invention, the present invention provides a method for controlling the position movement of icons on a touch screen of a portable terminal, including: displaying at least one icon on a display unit; generating at least one of a preset touch event and a preset input signal in at least one of an area of the display unit and an area displaying a selected one of the at least one icon; and setting a position movement locking function for the at least one icon, according to the generated at least one preset touch event and preset input signal.

In accordance with another exemplary embodiment of the present invention, the present invention provides a portable terminal serving to control icon position movement, including: a display unit for displaying at least one icon; a touch sensor for generating a touch event according to a user input in at least one of a certain area of the display unit and an area where a selected one of the at least one icon is displayed; and a controller for setting a position movement locking function for the selected icon according to the touch event.

### BRIEF DESCRIPTION OF THE DRAWINGS

The features and advantages of the present invention will become more apparent from the following detailed description in conjunction with the accompanying drawings, in which:

FIG. 1 is a schematic block diagram illustrating a configuration of a portable terminal according to an embodiment of the present invention;

FIG. 2 is a detailed view illustrating the controller shown in FIG. 1;

FIG. 3 illustrates screens according to the arrangement of icons, according to an embodiment of the present invention;

FIG. 4 illustrates screens that describe the icon locking/releasing functions, according to an embodiment of the present invention; and

FIG. 5 is a flow chart that describes a method for locking an icon position, according to an embodiment of the present invention.

### DETAILED DESCRIPTION OF THE INVENTION

Exemplary embodiments of the present invention are described in detail with reference to the accompanying drawings. The same reference numbers are used throughout the drawings to refer to the same or similar parts. For the purposes of clarity and simplicity, detailed descriptions of well-known functions and structures incorporated herein may be omitted to avoid obscuring the subject matter of the present invention.

Prior to explaining the embodiments of the present invention, terminologies will be defined for the present description below. The terms or words described in the present description and the claims should not be limited by a general or lexical meaning, instead should be analyzed as a meaning and a concept through which the inventor defines and describes the present invention at his most effort, to comply with the idea of the present invention. Therefore, one skilled in the art will understand that the embodiments disclosed in the description and configurations illustrated in the drawings are only preferred embodiments, instead there may be various modifications, alterations, and equivalents thereof to replace the embodiments at the time of filing this application.

In the following description, a touch down event refers to an event that occurs on a display unit of the touch screen under which touch sensors are arrayed when the touch sensors detect the touch of a user's finger or an object. A touch up event refers to an event that occurs when a user's finger or a touched object is removed from the touch sensors.

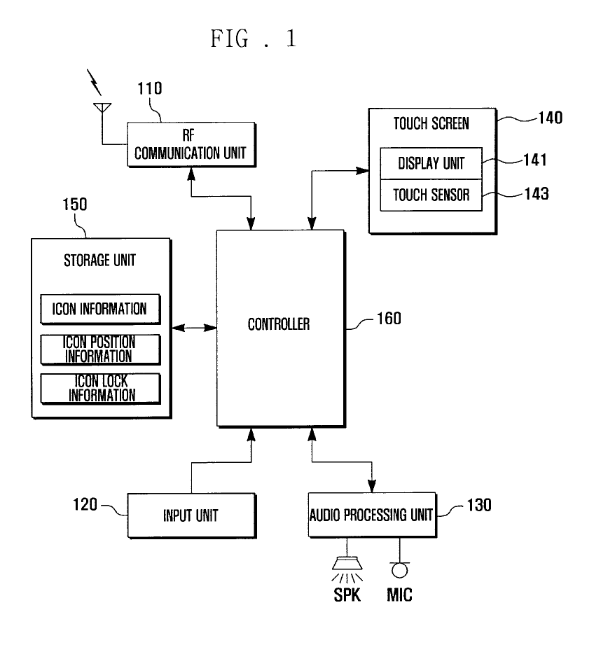

FIG. 1 is a schematic block diagram illustrating a configuration of a portable terminal 100 according to an embodiment of the present invention.

Referring to FIG. 1, the portable terminal 100 includes an RF communication unit 110, an input unit 120, an audio processing unit 130, a touch screen 140, a storage unit 150, and a controller 160.

The portable terminal 100 according to the present invention can fix the positions of particular icons on a display unit 141 of the touch screen 140. That is, the particular icons whose position is fixed cannot be moved on the display unit 141 by a user's touch drag. Rather the fixed (locked) icons retain their position. Therefore, the display unit 141 according to the present invention can be adaptively controlled although an unintended touch event has occurred. In the following description, each of the elements included in the portable terminal 100 will be explained in detail.

The RF communication unit 110 establishes a communication channel for performing a voice call or a communication channel for transmitting data, such as video data, etc., under the control of the controller 160. That is, the RF communication unit 110 establishes a voice or video call channel, and a data communication channel with a mobile communication system. To this end, the RF communication 110 includes an RF transmitter for up-converting the frequency of transmitted signals and amplifying the signals for transmission and an RE receiver for low-noise amplifying received RF signals and down-converting the frequency of the received RF signals. The RF communication 110 corresponds to a particular icon, and this icon may be displayed at a particular position on the display unit 141. When a portable terminal user activates a function corresponding to the RF communication 110 by touching an icon displayed on the display unit 141, a corresponding communication service is served. For example, examples of the icon corresponding to the RF communication 110 may be an icon for supporting a message service, an icon for supporting an email service, an icon for supporting a video call service, etc. These icons may be fixed at corresponding positions or to be movable, according to the user's operation.

The input unit 120 includes a plurality of input keys and function keys that input numerical or alphabetical information and set various functions. The function keys include direction keys, side keys, short keys, etc., to execute particular functions. The input unit 120 generates key signals related to a user's setting and function control of the portable terminal 100, and outputs them to the controller 160. The input unit 120 may be implemented with a QWERTY keypad, a 3×4 keypad, a 4×3 keypad, etc., which is composed of a plurality of keys. If the portable terminal 100 is provided with a full touch screen, the input unit 120 implemented with a keypad may be omitted. In that case, the portable terminal 100 of the present invention may output a key map corresponding to the keypad of the input unit 120 on the touch screen. The key map may be implemented with an icon key. In that case, the icon key may be fixed at a particular position on the display unit or to be movable according to a user's settings.

The audio processing unit 130 includes a speaker SPK for outputting audio data during a call and a microphone MIC for receiving a user's voice or audio signals. The audio processing unit 130 can adjust the audio volume according to an input signal generated by a particular key of the input unit 120. The audio processing unit 130 is represented as an icon corresponding to a speaker SPK or a microphone MIC on the display unit 141. In that case, the portable terminal user activates function corresponding to the speaker SPK or the microphone MIC by touching the appropriate icon to control the audio volume of the speaker SPK or the microphone MIC, for example. The icon corresponding to the speaker or the microphone MIC may be fixed at a particular position of the display unit 141 according to a user's settings or be movable on the display unit 141 according to a user's touch drag.

The touch screen 140 includes a display unit 141 and a touch sensor 143. The touch screen 140 may be configured in such a way that the touch sensor 143 is arrayed on the front side of the display unit 141. The touch sensor 143 may be larger than the area of the display unit 141 or may partially cover the display unit 141 according to the design. The touch screen 140 can be designed so that the touch sensor 143 and the display unit 141 are independently driven. That is, while the display unit 141 is being activated, the touch sensor 143 may be deactivated or activated in a certain area or may be activated over all areas.

The display unit 141 displays menus of the portable terminal 100, and information input by a user or provided to the user. That is, the display unit 141 provides various types of screens according to the operation of the portable terminal 100, such as an idle screen, menu screens, a message writing screen, a call screen, etc. The display unit 141 may be implemented with a liquid crystal display (LCD), an organic light emitted diode (OLED), etc. In an embodiment of the present invention, the display unit 141 can display a variety of icons according to a user's settings. The icons may be fixed at corresponding positions set by a user on the display unit 141 or may move their positions according to a user's settings. For example, if the portable terminal 100 is equipped with a full touch screen and provides an icon entry or icon menu thereon (the embodiments of the present invention is hereinafter explained with respect to the icon entry), the portable terminal user can activate the icon entry by touching a corresponding area (icon entry area) of the touch screen 140 or using the menu, and then touches and drags a particular icon in the icon entry area to another area of the display unit 141. The icon entry area may be displayed on the display unit 141 while the menu is being activated or a particular touch event is being generated and then removed from the icon entry area by a touch event corresponding to a removal command. Although the icons of the icon entry area may be removed from the display unit 141 through a removal command, the icons touch-dragged from the icon entry area to another area of the display unit 141 may continue to be displayed in the icon entry area. In one aspect of the invention, the portable terminal 100 collects icon information, icon position information and icon locking information and stores and manages the collected information in a list or table. The icons included in the icon entry area refer to icons corresponding to user functions of the portable terminal 100, such as an icon corresponding to a message service, a screen adjusting icon, a preference setting icon, a phonebook icon, a planner icon, a file icon, a schedule icon, a time icon, etc. The icons may include a widget icon that periodically downloads information from web servers according to a predetermined period of time or a user's time setting and displays it on the display unit 141, where the downloaded information may be weather information, financial information, stock information, news, etc.

The touch sensor 143 is configured to cover the display unit 141. The touch sensor 143 generates a touch event according to the touch of an object (icon) or the sensing of limited distance to the object and then outputs it to the controller 160. The touch sensor 143 transfers a variety of events according to a user's touch steps to the controller 160. For example, the touch sensor 143 can generate a touch down event at a time point when the user's finger touches the touch sensor 143. The touch sensor 143 may also generate a touch drag event or a touch move event when the user's finger touches down and simultaneously moves on the touch sensor 143 in a certain direction. When a touch down event or a touch drag event has occurred and then the user's finger is removed from the touch sensor 143 over a certain distance, the touch sensor 143 may generate a touch-up event or a touch release event. The touch sensor 143 may monitor for the presence a touch event periodically (e.g., every 25 ms). Therefore, the touch sensor 143 generates a touch event and transfers it to the controller 160 at every period of time, 25 ms, from when the user's finger touches the touch sensor 143. In another aspect of the invention, the detection of a touch down event may generate an interrupt, which is obtained and provided to the controller 160. Similarly, a touch up event may also generate an interrupt, which is obtained and provided to the controller 160.

The storage unit 150 stores an application program required to operate the functions according to an embodiment of the present invention, an application program for operating a touch screen, an icon operating program for supporting an icon locking function, icon position information generated when the icon operating program is executed, icon locking information, a locked icon list, etc. The storage unit 150 is composed of a program storing area and a data storing area.

The data storing area refers to an area where data, generated when the portable terminal 100 is used, is stored. That is, the data storing area stores a variety of contents. When the display unit 141 is implemented with a touch panel, the data storing area can store user's input via the touch panel. In an embodiment of the present invention, the data storing area stores icon information, icon position information, and icon locking information. The icon information contains color information and type information regarding icons displayed on the display unit, link information regarding an application program executed when a corresponding icon is activated, etc. The icon position information contains information regarding positions where icons are located on the display unit when the display unit is activated in order to identify which position in the icon entry area an icon belongs to or whether an icon moves from the icon entry area to a particular position on the display unit 141 under the control of a user's touch. The icon locking information contains information as to whether an icon needs to move or continue to be located at the present position when a touch event has occurred. The icon locking information may be changed when the user changes its settings. When a plurality of icons have position information regarding a particular point on the display unit, the portable terminal recognizes corresponding icons as a group of icons, and thus allows the movement of the group of icons to be locked or released. The portable terminal 100 may also support a function so that the icons can be individually locked or released. For example, when a plurality (i.e., 2) of icons has at least one point in common, the corresponding icons may be classified as a group.

The program storing area stores an operating system (OS) for starting (i.e., booting) the portable terminal 100 and operating elements included therein. The program storing area also stores application programs for reproducing a variety of files, such as an application program for supporting, for example, a voice call function, a web browser function for accessing an Internet server, an application program for audio sources, such as an MP3 file, an application program for reproducing photographs, images, moving images, etc.

In an embodiment of the present invention, the program storing area stores a touch screen operating program for operating touch sensors included in the touch screen. The program storing area stores an icon operating program. The icon operating program supports an operation to check whether a touch event output from the touch sensor 143 can be applied to the movement of an icon, associating the movement with a touch screen operating program and activating the touch screen operating program. That is, if the icon position movement releasing function is set, when a touch movement action of a touch drag action is applied to a corresponding icon, the icon operating program moves the icon to a certain distance in the direction which the action is applied and simultaneously updates the previous position information regarding the icon with the current position information. However, if the icon position movement locking function is set regarding particular icons, although a touch event corresponding to the movement of the icons by a touch movement action or a touch drag action occurs on the particular icons, the icon operating program can retain the icon position information stored in the storage unit.

The controller 160 supplies electric power to elements in the portable terminal 100 and initializes them. After that, the controller 160 performs a setting operation so that the elements can support icon control functions according to an embodiment of the present invention. That is, when the display unit 141 is activated, the controller 160 identifies icon information regarding icons to be displayed, and displays the icons at a particular point on the display unit 141 based on the position information regarding the icons. The controller 160 determines whether corresponding icons move or retain their current positions in response to a touch event that occurs on the corresponding icons based on the icon locking information.

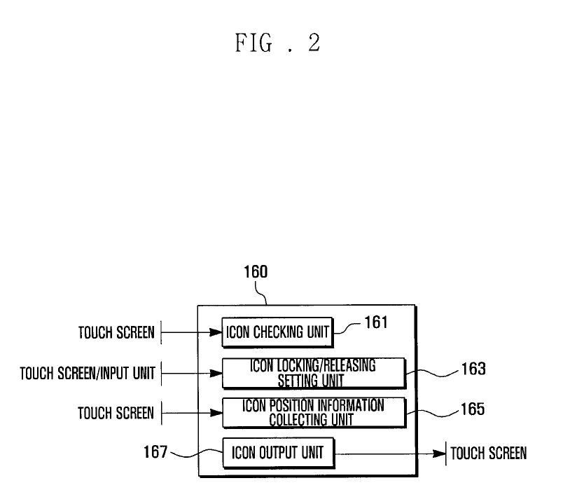

Referring to FIG. 2, the controller 160 includes an icon checking unit 161, an icon locking/releasing setting unit 163, an icon position information collecting unit 165, and an icon output unit 167.

The icon checking unit 161 monitors the touch screen 140 and checks whether an input signal for continuing to display an icon moved from the icon entry area to another area of the display unit 141 and an input signal for removing an icon displayed on a certain area of the display unit 141 are generated. The icon checking unit 161 detects whether an input signal, related to an icon that will be output or is being output on the display unit 141, is generated. If the portable terminal is equipped with a full touch screen, the icon checking unit 161 can check a state of an icon according to a touch event that occurred on the touch screen 140. That is, the icon checking unit 161 can check a touch event for moving an icon from the icon entry area to another area of the display unit 141, a touch event for removing an icon from a certain area of the display unit 141, a touch event related to icon locking/releasing, etc., and outputs a corresponding touch event to the icon position information collecting unit 165, the icon output unit 167, and the icon locking/releasing setting unit 163.

The icon locking/releasing setting unit 163 serves to lock or release the position of icon according to a touch event output from the icon checking unit 161. The icon locking/releasing setting unit 163 can automatically lock the position of a corresponding icon if the icon checking unit 161 ascertains that a preset touch event, for example a tapping signal successively generated within a certain period of time, or a touch down event lapsing for a preset time period has occurred on the corresponding icon. If a preset touch event has occurred on an icon set in a locking function, the icon locking/releasing setting unit 163 automatically releases the locking function with respect to the icon. If a preset touch event has occurred on a particular icon, the icon locking/releasing setting unit 163 outputs a pop-up window (not shown) to change the setting of the position movement locking function of the icon. For example, if an icon is set in a position movement locking function, the pop-up window shows a message asking whether to release the position movement locking function. On the contrary, if a position movement locking function is not set in an icon, the pop-up window may show a message asking whether to set the position movement locking function.

In another aspect, if a preset second touch event occurs on a particular area of the touch screen 140, for example one or more tapping signals successively generated within a certain period of time in a certain area where an icon is not displayed, or a touch down event lapsing for a preset time period occurs (not shown) the icon locking/releasing setting unit 163 can set or release the position movement locking function with respect to all the icons currently being displayed on the display unit 141. The icon locking/releasing setting unit 163 outputs a pop-up message asking whether to set or release the position movement locking function with respect to all the icons, and then performs a corresponding function according to the selection in the pop-up message. In the foregoing description, the preset touch event or the preset input signal may be set in such a way that the method for setting the position movement locking function is identical to, or differs from, the method for releasing the position movement locking function. The preset touch event and the preset input signal may be provided in a toggle mode to make it easy to operate a locking/releasing function. It is preferable that the touch event and the input signal be set with the same method.

The icon position information collecting unit 165 serves to identify position information regarding icons displayed on the display unit 141. That is, the icon position information collecting unit 165 collects position information regarding the icons displayed at a particular position on the display unit 141. For example, if a portable terminal user generates an input signal or a touch event to activate the icon entry, the portable terminal may output a screen (not shown) corresponding to the icon entry on the display unit 141. The user taps a particular icon on the screen corresponding to the icon entry, touch-drags or touch-moves it, and moves it to a certain area of the display unit 141 on which the icon entry is not output. During this process, the icon position information collecting unit 165 t racks position information regarding an icon on which the touch drag has occurred and then collects position information regarding a point where the touch drag has been released, i.e., a touch up event has occurred. The icon position information collecting unit 165 collects position information regarding all the icons moved to a particular area of the display unit 141 and stores the collected position information. The stored position information is used as reference information regarding positions at which corresponding icons will be displayed, when the portable terminal is rebooted or the display unit 141 is switched off and then displays the icons again. The position information may also be used as reference information to determine the positions at which the icons will be displayed in a state where the entire screen of the display unit 141 is slid. The icon position information collecting unit 165 can collect position information regarding the icon, based on the display unit 141. If a screen is larger than the display unit 141 and only a portion of screen is visible on the display unit 141, the icon position information collecting unit 165 identifies which position the information regarding the icon corresponds to, based on the screen which is larger than the display unit 141, and then collects corresponding position information.

The icon output unit 167 outputs icons on the display unit 141 based on the position information, collected by the icon position information collecting unit 165, and the icon locking information set by the icon locking/releasing setting unit 163. The icon output unit 167 also controls the outputting operation according to the position movement of the icons or the output of the icons according to the screen movement of the display unit 141, based on a touch event occurrence. In order to improve the size limitation of the display unit 141, the portable terminal 100 sets the screen size to be larger than that of the display unit 141, and moves the screen according to a touch event that occurred on a touch screen or an input signal generated via the input unit. It is preferable that the icon output unit 167 controls the icons to be output based on the entire screen, whose size is set to be larger than that of the display unit 141, and the position information regarding the icon. The icon output unit 167 distinguishes a layer displaying the icon and a layer displaying a background screen, according to a user's settings. In that case, if an input signal corresponding to a user's screen movement request is generated, the icon output unit 167 moves only the background screen and simultaneously outputs the icons at the current position. The portable terminal may provide a menu composed of items corresponding to a simultaneously moving function of icons according to the background screen movement, a current position maintaining function of icons, and a background screen moving function, etc., thereby providing user convenience.

As described above, the portable terminal according to an embodiment of the present invention can provide a position movement locking function to prevent the position movement of icons on the display unit although a touch event occurs on the icons, so that the icons can be prevented from moving due to unintentional touch events generated on the touch screen.

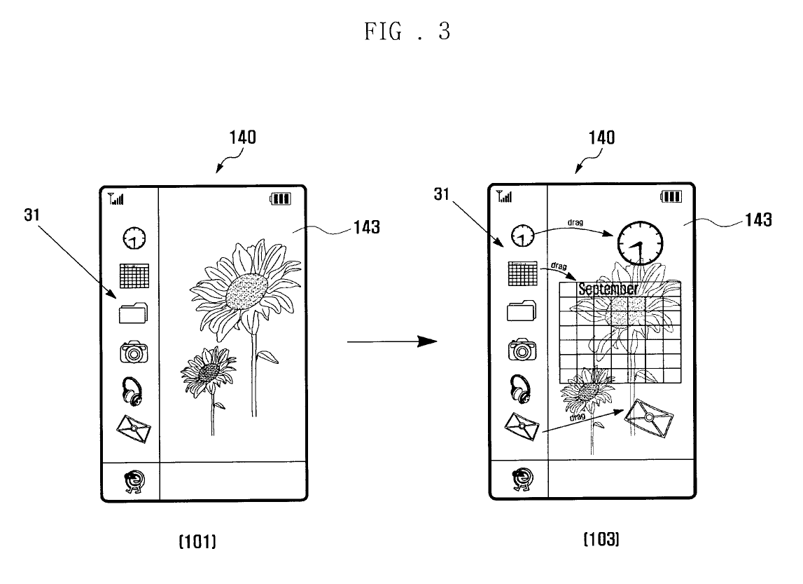

FIG. 3 illustrates screens (101, 103) according to the arrangement of icons, according to an embodiment of the present invention.

Referring to FIG. 3, the touch screen 140 includes a display unit area and an icon entry area 31 overlaying a part of the display unit area. After the portable terminal is booted up, it outputs a preset idle screen on the display unit 141. After that, as shown in screen 101, the portable terminal displays an entry area 31 overlaid at left side of the touch screen 140.

As shown in FIG. 3, the icon entry area 31 includes a variety of icons, such as a clock icon, a schedule icon, a file icon, a picture icon, a file playback icon, a message icon, a web browser icon, etc. The icon entry area 31 may further include other types of icons. For example, if the icon entry area 31 includes many additional icons but the area overlying the display unit 141 is limited, the additional icons can be displayed by a user's touch event, such as a touch-drag, a touch move or flick, etc. To this end, the icon entry area 31 output on the display unit 141 may provide an additional screen as well as a screen currently being shown on the display unit 141 or may display additional icons through scrolling icons on the screen.

As shown in screen 103, selected ones of the icons in the icon entry area 31 may be moved from the icon entry 31 to a selected area of the display unit 141 according to a user's drag action. That is, if the portable terminal user applies a touch down to a particular icon in the icon entry area 31 and then drags the icon from the icon entry 31 towards the display unit 141, the touched icon can be moved from the icon entry area 31 to a point where the touch drag has been terminated (i.e., a touch-up event has occurred). For example, if the user drags the clock icon, schedule icon and message icon from the icon entry area 31 to corresponding selected positions (areas) on the display unit 141, respectively, the icons are moved to the positions indicated by the user. During this process, the icons change their state to differ from the state as shown in the icon entry area 3, and are displayed at the corresponding position. That is, while the clock icon is being displayed on the icon entry area 31 in such a size to be recognizable as a clock icon, when the clock icon is moved to a selected area on the display unit 141, the size of the icon is changed in such a way that the time can be read. That is the size of the icon may be changes to show the hour and minute hands indicating the current time. Likewise, while the schedule icon is being displayed on the icon entry area it is so small that its image cannot be read. However, when the schedule icon is moved to a selected area of the display unit 141, its image is enlarged so that schedules for today, this week, or this month can be read. Thus, the increase size of the icon enable a user to view one or more characteristics associated with the icon.

Although the embodiment of the present invention is explained in such a way that corresponding icons are moved and their size is altered, it should be understood that the present invention is not limited to the embodiment. For example, as shown in screen 103, the portable terminal can be implemented in such way that the corresponding icons can change size at a corresponding point when a touch-up event has occurred. Meanwhile, the message icon can be changed and displayed only in a size without displaying addition information.

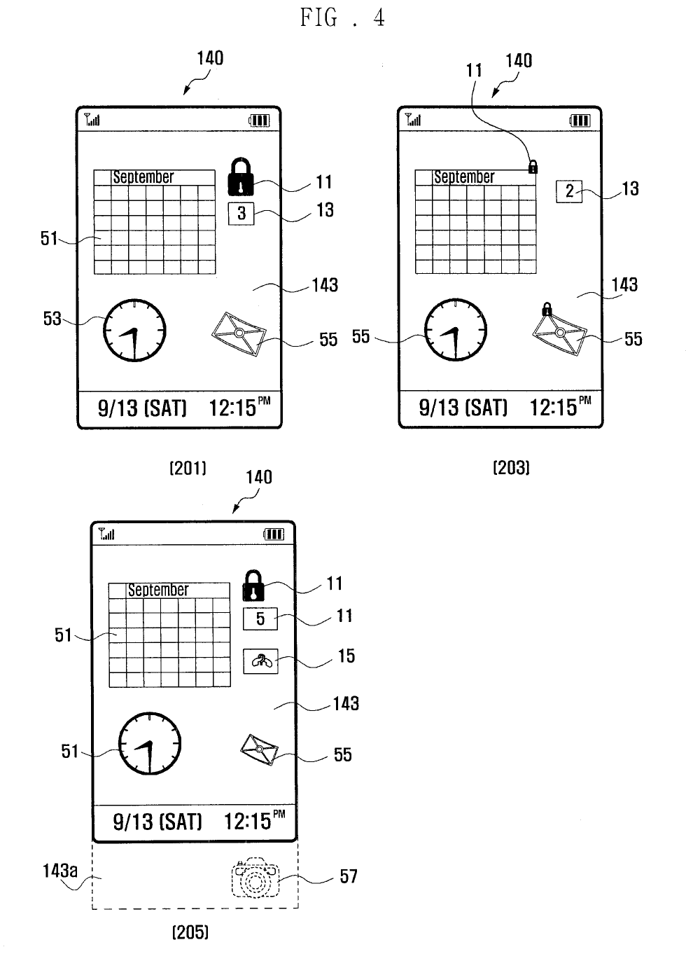

FIG. 4 illustrates screens (201, 203, 205) that describe the icon locking/releasing functions, according to an embodiment of the present invention.

Referring to FIG. 4, screen 201 shows a state that, after icons have been arranged on touch screen 140 (see screen 103 of FIG. 3), a command is performed to remove the icon entry area 31 from the display unit 141 and then icons, output on the display unit 141, are touch-dragged to be arranged in a selected position on the display unit 141. Screen 201 shows a state where the portable terminal user has set a position movement locking function for all the icons displayed on the display unit 141. To this end, the user may generate a touch event using a touch sensor of the touch screen 140. The icon locking function is set as follows. When the user generates a preset touch event, for example, a touch down state over a preset time period in a particular area of the display unit 141, i.e., an empty area on which the schedule icon 51, clock icon 53, and message icon 55 are not displayed, a long touch event, etc. is generated. The portable terminal can set a position movement locking function for the schedule icon 51, clock icon 53 and message icon 55, displayed on the display unit 141, according to the occurrence of the long touch event. When the position movement locking function has been set for all the icons on the display unit 141, the portable terminal can output a count area 13 for displaying the number of icons, set as the position movement locking function, and a lock icon 11 indicating whether icons currently output on the display unit 141 are set according to the position movement locking function. The lock icon 11 can be displayed on the display unit 141 only when an icon is locked and disappears when the lock state of the icon is released. The lock icon 11 may also be displayed with two icons indicating a position movement locking state and a position movement releasing state. As shown in FIG. 4, the icon in a locked state is illustrated in such a way that the ring of the lock is coupled to the body of the lock. Correspondingly, the icon in an unlocked state may be illustrated in such a way that the ring is separated from the body of the lock (not shown). It should be understood that the icon in a locked state can be shown in various shapes according to the design of the icon.

When the long touch event in the empty position has been detected, the portable terminal does not automatically set the position movement locking function to the schedule icon 51, clock icon 53 and message icon 55, but instead outputs a pop-up window (not shown) to check whether a position movement locking function has beet set.

If the portable terminal user selects a position movement locking function via the pop-up window (not shown), the portable terminal performs a control operation to set the position movement locking function.

The portable terminal may also set the position movement releasing function via the same method as the position movement locking function. That is, if a position movement locking function is set for all of the icons displayed (i.e., schedule icon 51, clock icon 53, and message icon 55), on the display unit 141, and a long touch event has occurred, the portable terminal automatically releases the position movement locking function or outputs a pop-up window (not shown) asking whether the position movement locking function is intended to be released.

In the embodiment of the present invention described above, the touch event is explained based on a long touch event, it should be understood, however, that the present invention is not limited to the embodiment. For example, the touch event may also be implemented with various touch events, for example, two or more touch events successively generated within a preset period of time, a preset touch pattern, etc. The preset touch pattern may be a certain shape, for example, a polygon, such as a triangle, a rectangle, etc., an ellipse, a half circle, a particular symbol, etc. drawn in a certain area of the display unit 141 using the user's finger When a touch event corresponding to a certain shape has occurred on the display unit 141, the portable terminal detects the shape and sets the position movement locking or releasing function, according to the detected touch event.

As described above referring to screen 201, the portable terminal according to the present invention can integrally set a position movement locking or releasing function for all the icons to thus fix or move the positions of a variety of icons output on the display unit 141.

As shown in screen 203, the portable terminal can set a position movement locking function for a portion of the icons. That is, the portable terminal user can individually set a position movement locking function with respect to the schedule icon 51 and the message icon 55. To this end, the user can generate a preset touch event, for example, a long touch event, with respect to the schedule icon 51 and the message icon 55. The portable terminal can automatically set a position movement locking function for icons on which the long touch event has occurred. If a long touch event has occurred on icons that are locked, the portable terminal performs a control operation to release the position movement locking function from the icon. Furthermore, the portable terminal can output a pop-up message (not shown) asking whether the position movement locking or releasing function is set for an icon on which a long touch event has occurred, and then set the function, corresponding to a user's selection, for the icon. In the illustrated example shown, a lock icon 11 informing the user that a corresponding icon has been set in a position movement locking function may be output in a certain area of the schedule icon 51 and message icon 55. In addition, a count area 13 may be output to one side of the display unit 141, indicating the number of icons, set in a position movement locking function, from among the icons currently output on the display unit 141. For example, as shown in screen 203, the number of icons set in a position movement locking function is two, i.e., a schedule icon 51 and a message icon 55, while three (3) icons are displayed.

Setting a position movement locking function for a portion of the icons provides convenient usage of the portable terminal. For example, if the portable terminal is a slide type, the user can hold the portable terminal, apply force to part of the body of the portable terminal, i.e., part of the touch screen 140, using the thumb, and then move the thumb in a certain direction. In that case, the thumb may generate a touch down event on the touch screen 140 and the motion in a certain direction may also generate a touch event corresponding to a touch-drag. If an icon position movement locking function is set to only the icons, arrayed on a certain area of the touch screen 140 and mainly touched by the thumb, for example, a schedule icon 51 or message icon 55, the portable terminal can prevent the positions of the icons from moving due to unintentional touch events.

While a position movement locking function is set for a portion of all the icons output on the display unit 141 as shown in screen 203, the portable terminal can support a function for locking or releasing all of the icons as shown in screen 203. That is, when the portable terminal user generates the long touch event in a certain area of the display unit 141, the portable terminal can automatically perform an icon position movement locking or releasing function with respect to all of the icons output on the display unit 141. If the number of icons set in a position movement locking function is smaller than that of icons set in a position movement releasing function, the portable terminal automatically locks all of the icons. Otherwise, the portable terminal automatically releases all of the icons. In addition, the portable terminal can also output a pop-up message (not shown) asking whether the entire icon locking function is set or released.

Screen 205 describes a case where the screen is set in such a way that its size is larger than that of the display unit 141 and a case where an icon is displayed at a preset position as a particular user function of the portable terminal is activated. The portable terminal user can move a schedule icon 51, a clock icon 53, a message icon 55 and a camera icon 57 from the icon entry area 31 to corresponding selected areas of the display unit 141. During the process of moving icons, as shown in screens 201 and 203, the schedule icon 51, the clock icon 53, a call state icon 15, and the message icon 55 are output to a certain area of the display unit 141. However, the camera icon 57 can be moved to an additional screen area 143a that does not appear on the display unit 141, due to the spatial limitation of the display unit 141 or a user's preference. In that case, the display unit 141 displays only the schedule icon 51, clock icon 53, message icon 55, and call state icon 15, but does not display the camera icon 57 that is located in the additional screen area 143a. The portable terminal user can generate a touch event on the display unit 141, such as a touch drag, a flick, etc., to check the additional screen area 143a, so that the camera icon 57 in the additional screen area 143a can appear on the display unit 141. While the camera icon 57 is being displayed on the display unit 141, the upper portion of the screen is newly set to an additional screen area and scrolls up and disappears from the display unit 141. As shown in screen 205 and similar to that shown in screen 201, the portable terminal user can set the entire icon locking function with respect to all the icons displayed on the display unit 141. In that case, the portable terminal can also set the position movement locking function for the camera icon 57 located in the additional screen area 143a. Therefore, the count area can display the number of icons that are locked, from among all the icons displayed on the display unit 141. In an embodiment of the present invention, the number of icons that are locked is five. Meanwhile, the portable terminal does not set the position movement locking function for the camera icon 57 located in the additional screen area 143a, according to the design purpose or a user's settings. That is, if the entire icon locking function is set for only the icons displayed on the display unit 141, the portable terminal can exclude the icons located in the additional screen area 143a, from among the icons included in the entire screen.

The call state icon 15 can be displayed on the display unit 141 as a call function is being executed. As shown in screen 205, the call state icon 15 indicates two missed calls. When the call state icon 15 is moved from the icon entry area 31 to the display unit 141, if there is call related information, i.e., no missed calls, the call state icon 15 is not displayed on the display. That is, the call state icon 15 does not appear in a certain area on the display unit 141 until information related to one or more calls is generated. The call state icon 15 is displayed in a certain area of the display unit 141 according to information regarding a position of the display unit 141 to which it was first moved from the icon entry. A determination whether a position movement locking function is set to the call state icon 15 can be made according to the state of a position movement lock set for the display unit 141. That is, if the entire icon locking function is set to cover all of the icons currently output on the display unit 141, the call state icon 15 can be set in its position movement lock position, according to the setting of the entire icon locking function. Therefore, if the call state icon 15 is generated according to the call function activation, it is recognized that a position movement locking function is additionally set the corresponding icon, so the count area 13 increases its count. That is, while the count area 13 is outputting ‘4’ before information related to a call state is generated, it then outputs ‘5’ when information related to a call state is generated and a call state icon 15 is presented on the display and the call state icon has an associated position movement locking function.

As described above, the portable terminal includes a call state icon 15 generated as a call function is activated. In addition, the portable terminal may also include a variety of functions of the portable terminal, such as a call service, a message reception icon, a file transfer complete icon, an icon notifying the user of data reception from a server if the portable terminal has a widget function, etc. The call service, message reception icon, file transfer complete icon, data reception notifying icon, etc. can be displayed on the display unit 141 when the portable terminal user function is activated.

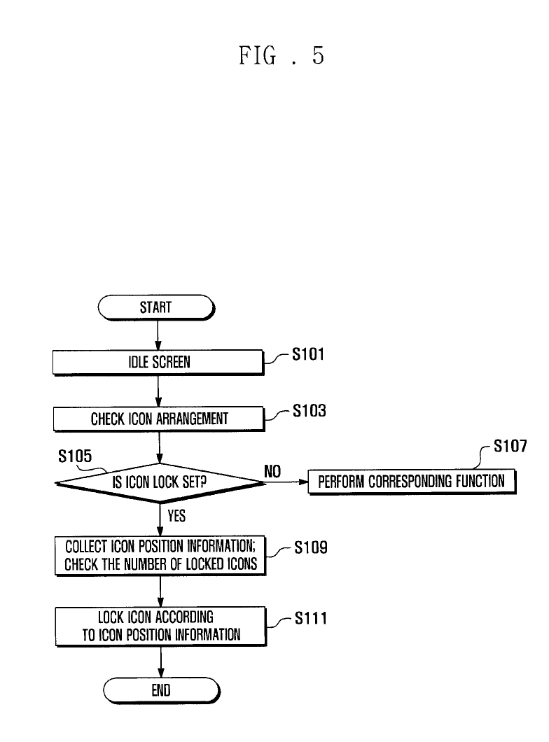

In the foregoing description, the elements for providing an icon locking function of the portable terminal, the operation of the elements, and the user interfaces have been explained. In the following description, an icon locking method of the portable terminal is explained in detail with reference to FIG. 5.

FIG. 5 is a flow chart that describes a method for locking an icon position, according to an embodiment of the present invention.

Referring to FIG. 5, after the portable terminal is turned on and has initialized its elements, it outputs a preset idle screen on the display unit (S101). The idle screen is displayed when the portable terminal is operated from a standby state where at least electrical power is supplied to a state where the standby state is released according to a user' input signal. Although the icon locking method, according to an embodiment of the present invention, is explained in such a way that icons are displayed on a display unit on which an idle screen is being displayed, it should be understood that the present invention is not limited to the described embodiment. For example, the icons can also be displayed on a display unit that displays a variety of screens according to the activation of other user functions, e.g., a screen for searching photographs, a camera function screen, etc.

After that, the portable terminal checks the arrangement of icons (S103). That is, when the portable terminal user moves a particular icon from the icon entry area 31 or other icon setting menu(s) to the display unit showing the idle screen, the portable terminal can check the arrangement of the moved icons on the display unit. Therefore, the portable terminal can collect information regarding the positions of icons on the idle screen, respectively.

Next, the portable terminal determines whether a position movement locking function is set to an icon (S105). If the portable terminal ascertains that a position movement locking function is not set to an icon at S105, it performs a corresponding function when is activated (S107). For example, the portable terminal performs various functions of the icons displayed on the idle screen, such as file playback, file search, image capture, broadcast reception, scheduling, etc.

The position movement locking function for an icon at step S105, as shown in FIG. 5, includes a function for integrating all of the icons displayed on the idle screen and setting a position movement locking for them when a preset touch event or an input signal is generated, a function for setting a position movement locking function for a portion of the icons displayed on the idle screen, respectively, when a preset touch event or an input signal is generated, and a function for integrating all of the icons displayed on the display unit in the idle screen and setting a position movement locking to them when a preset touch event or an input signal is generated. The preset touch event or the input signal may be a touch event or an input signal that is generated in a particular area of the display unit or on a particular icon.

However, if the portable terminal ascertains that a position movement locking function is set for an icon at S105, it collects position information regarding icons set in a position movement locking function and checks the number of locked icons (S109). That is, the portable terminal checks which icons are locked, using the position information that is collected based on the arrangement state of the icon checked at S103, and then stores the checked information in the storage unit. In addition, during the process of setting a position movement locking function, the portable terminal checks the number of icons set in a position movement locking function, and displays the information at one side of the screen so that the user can read it. If there are icons, displayed on the idle screen when the user function is activated, from among the icons set in a position movement locking function, the portable terminal concludes that a position movement locking function is additionally set to icons when corresponding icons are displayed on the display unit, and then increases and displays the count. It should be understood that icons output on the idle screen when the user function is activated may be moved to the display unit, together with other icons, and then continue being displayed, according to a user's setting or the design purpose.

Next, the portable terminal fixes icons based on position information regarding the icons, respectively (S111). That is, the portable terminal can be operated in such a way that the icons set in a position movement locking function are not moved by a touch-drag, touch move, flick, etc., but retain their current positions. When a touch event for moving the position of icon, such as a touch-drag, touch move, flick, etc., occurs on an icon set in a position movement locking function, the portable terminal may further output a pop-up message (not shown) notifying the user that the icon is set in a position movement locking function.

Although an embodiment of the portable terminal according to the present invention has been explained based on the icon position movement locking, it should be understood that the portable terminal can also support the icon position movement releasing function that releases the icon position movement locking set for an icon. That is, if a preset touch event or an input signal is generated on a particular icon or in a certain area of the display unit, the portable terminal releases all or part of the icons set in a position movement locking function.

As described above, the icon position controlling method and the portable terminal adapted to the method, according to the present invention, can fix at least one of a plurality of icons or can fix icons by groups on a touch screen, according to a user's selection, thereby supporting a stable screen interface, event though unintentional touch events have occurred on the touch screen.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be executed by such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein. As would be recognized by those skilled in the art, when a general purpose computer is loaded with, or accesses, software or code for implementing the processing shown herein, the general purpose computer is transformed into a special purpose computer that may at least perform the processing shown herein.

Although exemplary embodiments of the present invention have been described in detail hereinabove, it should be understood that many variations and modifications of the basic inventive concept herein described, which may be apparent to those skilled in the art, will still fall within the spirit and scope of the exemplary embodiments of the present invention as defined in the appended claims.

What is claimed is:

1. A method for controlling the position movement of icons on a portable terminal, the method comprising:
displaying at least one icon on a display unit;
generating at least one of a preset touch event and a preset input signal in at least one of an area of the display unit and an area displaying a selected one of the at least one icon; and
setting a position movement locking function for the selected icon, according to the at least one of preset touch event and preset input signal.

2. The method of claim 1, wherein displaying the at least one icon comprises:
displaying a screen according to the activation of a user function on the display unit; and
overlaying at least one icon on the screen.

3. The method of claim 2, wherein, if the screen, on which at least one icon is arranged, is larger than the size of the display unit so part of the icons in the screen are displayed on the display unit, the method further comprises:
arranging the remaining icons, included in the screen, in an additional screen area that does not appear on the display unit.

4. The method of claim 3, further comprising:
checking a number of icons set in a position movement locking function and arranged on a screen displayed on the display unit, from among the icons arranged on the screen; and
displaying the number of icons set in a position movement locking function and arranged on the display unit.

5. The method of claim 3, further comprising:
checking the number of icons, set in a position movement locking function, from among all of the icons arranged on the screen containing the additional screen area; and
displaying the number of icons that are set in a position movement locking function and arranged on the entire screen.

6. The method of claim 1, wherein setting a locking function comprises
setting a position movement locking function for all of the icons being displayed on the display unit if the at least one of preset touch event and preset input signal is generated in an area of the display unit.

7. The method of claim 6, further comprising:
displaying a lock icon on a particular area, where the lock icon indicates that all the icons displayed on the display unit are set in a position movement locking function.

8. The method of claim 6, further comprising:
generating at least one of a preset touch event and a preset input signal to release a locking function in a certain area of the display unit; and
releasing the locking function with respect to all the icons set in the position movement locking function.

9. The method of claim 8, wherein, if a lock icon according to the setting of the position movement locking function is being displayed on the display unit, the method further comprises:
removing, if the locking function is released, the lock icon from the display unit.

10. The method of claim 1, wherein setting a locking function comprises
setting a position movement locking function to a corresponding icon if a touch event occurs in an area where the icon is displayed.

11. The method of claim 10, further comprising:
displaying a lock icon for notifying a user of a locking function setting for an icon set with the position movement locking function.

12. The method of claim 10, further comprising:
generating at least one of a preset touch event and a preset input signal to release a locking function in a certain area where the icon is displayed; and
releasing the locking function with respect to the icon set in the position movement locking function.

13. The method of claim 12, wherein, if a lock icon according to the setting of the position movement locking function is displayed on the corresponding icon, the method further comprises:
removing, if the locking function is released, the lock icon from the corresponding icon.

14. The method of claim 1, further comprising:
displaying, if a particular user function is activated, an icon related to a corresponding user function on the display unit.

15. The method of claim 14, wherein the user function is at least one of a call servicing, a message servicing, a data transferring, and a file transferring.

16. The method of claim 14, further comprising:
checking, if a position movement locking function is set to the related icon, the number of icons, set in a locking function, from among the icons displayed on the display unit; and
displaying the number of icons that are set in the locking function, displayed on the display unit, where the number of icons contains the related icon.

17. A portable terminal serving to control icon position movement comprising:
a display unit for displaying at least one icon;
a touch sensor for generating a touch event, according to user input, in at least one of a certain area of the display unit and an area where the icon is displayed; and
a controller for setting a position movement locking function to at least one icon, according to the touch event.

18. The portable terminal of claim 17, wherein the controller:
sets a position movement locking function to all the icons being displayed on the display unit if the at least one preset touch event and preset input signal is generated in an area of the display unit;
sets a position movement locking function to a corresponding icon if a touch event occurs in an area where the icon is displayed; and
displays a lock icon in an certain area of one of the display unit and a certain area of the corresponding icon, where the lock icon indicates a state that the icon is set in a position movement locking function.

19. The portable terminal of claim 18, wherein, if the preset touch event has occurred in at least one of a certain area of the display unit and in the corresponding icon, the controller releases a locking function with respect to at least one of all the icons and the corresponding icon, to which the position movement locking function is set.

20. The portable terminal of claim 19, wherein, if a lock icon is displayed according to the setting of the position movement locking function, the controller removes the lock icon when the locking function is released.
